(19) United States
(12) Patent Application Publication
(10) Pub. No.: US 2012/0012716 A1
(43) Pub. Date: Jan. 19, 2012

(54) Self-secure mount for tubular object

(76) Inventor: Chin-Hsiung Lien, El Monte, CA (US)

(21) Appl. No.: 13/200,266

(22) Filed: Sep. 21, 2011

Related U.S. Application Data
(63) Continuation-in-part of application No. 12/148,005, filed on Apr. 16, 2008, now Pat. No. 8,033,512.

(51) Int. Cl. F16L 3/10; B23P 11/00

(52) U.S. Cl. 248/74.2; 29/446

(57) ABSTRACT

A self-secure mount for a tubular object includes an outer holder and an inner holder. The outer holder includes two spaced apart holding panels and a cornering panel extended between the two holding panels for applying an elastic clipping force between the holding panels. The inner holder includes two spaced apart clipping panels overlapping with each other to define a clipping channel therebetween, wherein two inner edges of the clipping panels are extended towards a closed end of the clipping channel. The two inner edges of the clipping panels are adapted for pressing against an outer surface of the tubular object to retain the tubular object in position, such that when the holding panels are pressed to minimize a distance therebetween, the clipping force of the outer holder is substantially increased towards the inner edges of the clipping panels to hold the tubular object within the cornering panel.

### CROSS REFERENCE OF RELATED APPLICATION

This is a Continuation-In-Part application that claims the benefit of priority under 35U.S.C. §119 to a non-provisional application having an application Ser. No. 12/148,005 and a filing date of Apr. 16, 2008.

### BACKGROUND OF THE PRESENT INVENTION

1. Field of Invention

The present invention relates to a method and a device of self-secure mount, and more particularly to the mount of tubular objects on walls, e.g. dry wall.

2. Description of Related Arts

For most currently used cable clamps, wire clips, and pipe mounts, there are two major disadvantages. The first issue is lacking of the adjustment for objects with different diameters. Most of the mounts have a fixed diameter. For every specific object with a specific diameter, a specific mount is required to match. Other wise, if the diameter of the mount is smaller than the diameter of the object, it can not hold the object; if the diameter of the mount is larger than the diameter of the object, the object can not be secured within the mount stably and can be sliding. While there are all different kinds of cables, wires, and tubes, it is difficult to find a mount which is just match. It also cost a lot of resources to fabricate mounts with the whole range of diameters. Some mounts have a rubber inner layer for fastening. But this rubber layer can only supply a small range of adjustment, it can not be applied to objects with large diameters, also the rubber aging will diminish the fastening effect.

Another disadvantage is the mounting process. In most cases, the object needs to be located first, then the mounts can be hooked with the object, and be fixed on the mounting surface. In this way, there is a period of time the object needs to be suspended without the support from the mount. This is inconvenient for the alignment of the object. The present invention will overcome those disadvantages.

### SUMMARY OF THE PRESENT INVENTION

An object of the present invention is to provide a self-secure mount to retain a tubular object on a fixture surface wherein the tubular object is secured by the mount without damaging the surface of the tubular object.

An object of the present invention is to provide a self-secure mount which is adapted to retain the tubular object by means of elastic force.

An object of the present invention is to provide a self-secure mount, wherein the manufacturing process of the self-secure mount is relatively simple and is in low cost.

An object of the present invention is to provide a self-secure mount which is made of a flexible thin metal plate being bent in a predetermined configuration such that the self-secure mount provides a simple structural configuration.

An object of the present invention is to provide a self-secure mount which is adapted to tubular objects with a large range of diameters.

Another object of the present invention is to provide a method of making a self-secure mount to fix tubular objects to a surface.

Another object of the present invention is to provide a method of using a self-secure mount to fix tubular objects to a surface.

An object of the present invention is to provide a self-secure mount, wherein no expensive or complicated structure is required to employ in the present invention in order to achieve the above mentioned objects. Therefore, the present invention successfully provides an economic and efficient solution for providing a rigid but flexible configuration for retaining the tubular object in position.

Accordingly, in order to accomplish the above objects, the present invention provides a self-secure mount for tubular object, comprising:

an outer holder, which is made of flexible material, comprising two spaced apart holding panels spacedly overlapping with each other, and an arc-shaped cornering panel integrally extended between the two holding panels for applying an elastic clipping force between the holding panels; and

an inner holder, which is also made of flexible material, comprising two spaced apart clipping panels overlapping with each other to define a clipping channel between the holding panels of the outer holder, wherein two outer edges of the clipping panels are integrally extended from two outer edges of the holding panels while two inner edges of the clipping panels are extended towards a closed end of the clipping channel within the cornering panel of the outer holder, wherein the two inner edges of the clipping panels are adapted for pressing against an outer surface of the tubular object to retain the tubular object in position, such that when the holding panels are pressed to minimize a distance therebetween, the clipping force of the outer holder is substantially increased towards the inner edges of the clipping panels to hold the tubular object within the cornering panel.

The present invention further provides a method of manufacturing a self-secure mount, comprising the steps of:

(a) providing an elongated thin metal plate which is divided into four longitudinal sections;

(b) overlappedly and spacedly folding two outer longitudinal sections on two inner longitudinal sections; and

(c) overlappedly and spacedly folding the two outer longitudinal sections with each other at a position that the two inner longitudinal sections are overlappedly and spacedly sandwiched between the two outer longitudinal sections to form a clipping channel between the two inner longitudinal sections, wherein the two outer longitudinal sections forms two clipping panels while the two inner longitudinal sections forms two holding panels, wherein when a tubular object is slid into the clipping channel to a closed end thereof, two inner edges of the clipping panels are adapted for pressing against an outer surface of the tubular object to retain the tubular object in position, such that when the holding panels are pressed to minimize a distance therebetween, the clipping force of the holding panels is substantially increased towards the inner edges of the clipping panels to hold the tubular object within the closed end of the clipping channel.

These and other objectives, features, and advantages of the present invention will become apparent from the following detailed description, the accompanying drawings, and the appended claims.

### TO BRIEF DESCRIPTION OF THE DRAWINGS

FIG. 1 is a perspective view of a self-secure mount for a tubular object according to a preferred embodiment of the present invention.

FIG. 2 is a sectional view of a self-secure mount according to the above preferred embodiment of the present invention.

FIG. 3 is a sectional view of a self-secure mount according to the above preferred embodiment of the present invention, illustrating the tubular object being retained within the clipping channel.

FIG. 4 illustrates a first alternative mode of the self-secure mount according to the above preferred embodiment of the present invention.

FIG. 5 illustrates a second alternative mode of the self-secure mount according to the above preferred embodiment of the present invention.

FIG. 6 illustrates a third alternative mode of the self-secure mount according to the above preferred embodiment of the present invention

FIG. 7 illustrates an alternative use of the self-secure mount for a bigger tubular object according to the above preferred embodiment of the present invention.

FIG. 8 is a flow diagram illustrating the manufacturing process of the self-secure mount according to the above preferred embodiment of the present invention.

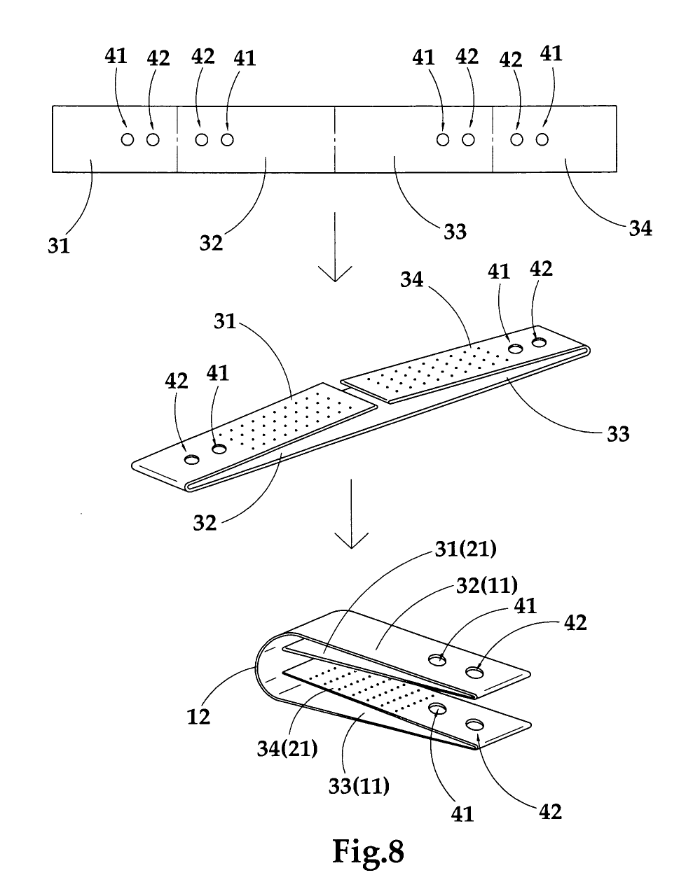

FIG. 9 is a sectional view of the forth alternative embodiment of the self-secure mount according to the above preferred embodiment of the present invention.

FIG. 10 is a sectional view of the forth alternative embodiment of the self-secure mount according to the above preferred embodiment of the present invention, illustrating the tubular object being retained within the clipping channel.

FIG. 11A is a side view of the fifth alternative embodiment of the self-secure mount.

FIG. 11B is a side view of the fifth alternative embodiment of the self-secure mount, illustrating the tubular object being retained within the clipping channel.

FIG. 12A is a perspective view of the sixth alternative embodiment of the self-secure mount.

FIG. 12B is a side view of the seventh alternative embodiment of the self-secure mount.

FIG. 13 is a side view of the eighth alternative embodiment of the self-secure mount, illustrating the tubular object being retained by one clipping panel.

FIG. 14 is a perspective view of a self-secure mount according to a ninth embodiment of the present invention.

FIG. 15 is a side view of the self-secure mount according to the above ninth embodiment of the present invention, illustrating the self-secure mount being made by an elongated thin metal plate.

FIG. 16 illustrates how to secure the tubular object by the self-secure mount according to the above ninth embodiment of the present invention.

### DETAILED DESCRIPTION OF THE PREFERRED EMBODIMENT

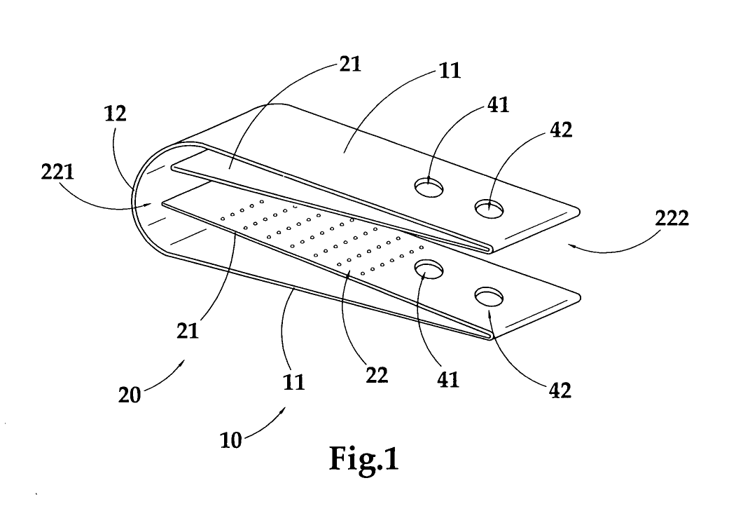

Referring to FIGS. 1 to 3 of the drawings, a self-secure mount according to a preferred embodiment of the present invention is illustrated, wherein the self-secure mount, which is adapted for retaining a tubular object 1 in position, comprises an outer holder 10 and an inner holder 20.

The outer holder 10, which is made of flexible material, comprises two spaced apart holding panels 11 spacedly overlapping with each other, and an arc-shaped cornering panel 12 integrally extended between the two holding panels 11 for applying an elastic clipping force between the holding panels 11.

The inner holder 20, which is also made of flexible material, comprises two spaced apart clipping panels 21 overlapping with each other to define a clipping channel 22 between the holding panels 11 of the outer holder 10, wherein two outer edges of the clipping panels 21 are extended from two outer edges of the holding panels 11 while two inner edges of the clipping panels 21 are extended towards a closed end 221 of the clipping channel 22 within the cornering panel 12 of the outer holder 10.

The two inner edges of the clipping panels 21 are adapted for pressing against an outer surface of the tubular object 1 to retain the tubular object 1 in position, such that when the holding panels 11 are pressed to minimize a distance therebetween, the clipping force of the outer holder 10 is substantially increased towards the inner edges of the clipping panels 21 to hold the tubular object 1 within the cornering panel 12. It is worth to mention that when the holding panels 11 are pressed towards each other, the clipping panels 21 are driven to be pressed at the same time such that the resilient force is generated at the inner edges of the clipping panels 21 to retain the tubular object 1 in position. In addition, since the tubular object 1 is clipped between the clipping panels 21 by means of resilient force, the outer surface of the tubular object 1 will not be damaged.

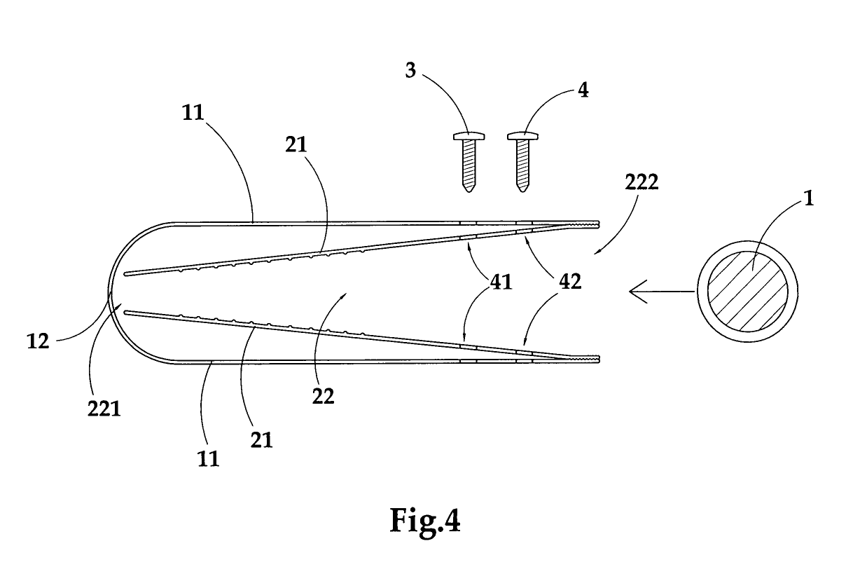

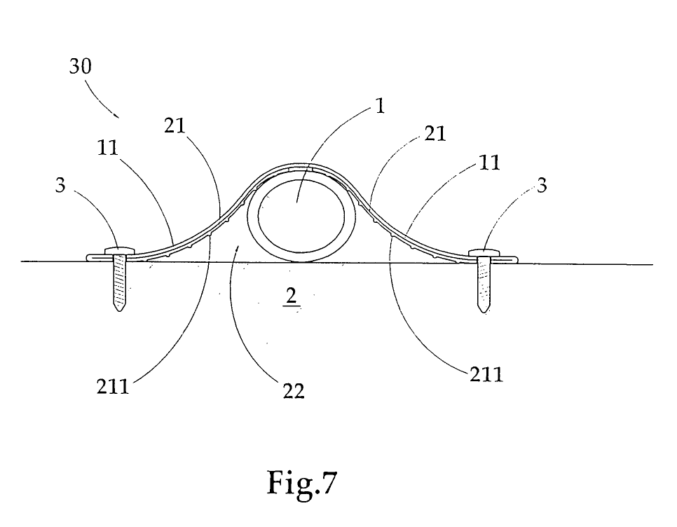

According to the preferred embodiment, two outer edges of the clipping panels 21 are integrally extended from two outer edges of the holding panels 11 by bending an elongated metal plate 30 as shown in FIG. 7. Alternatively, the two outer edges of the clipping panels 21 are affixed to the two outer edges of the holding panels 11 by welding as shown in FIG. 4.

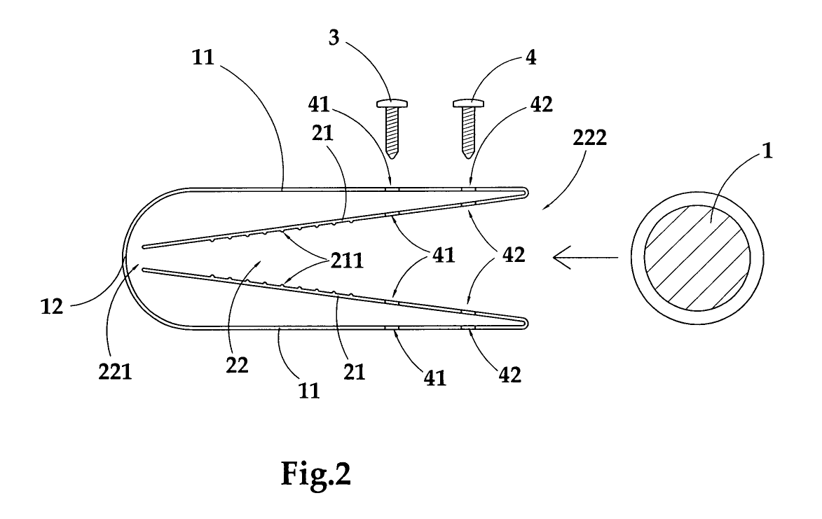

According to the preferred embodiment, the clipping channel 22 defines the closed end 221 at the cornering panel 12 and an opened end 222 at the outer edges of the clipping panels 21. A width of the clipping channel 22, which is a distance between the two clipping panels 21, is smaller than a diameter of the tubular object 1. Preferably, the width of the clipping channel 22 is gradually reducing from the opened end 222 to the closed end 221, as shown in FIG. 2.

The outer holder 10 is formed to have a U-shape that the two holding panels 11 are preferably extended in a parallel manner, wherein the cornering panel 12 is preferred to be formed in a U-shaped structure, as shown in FIG. 2.

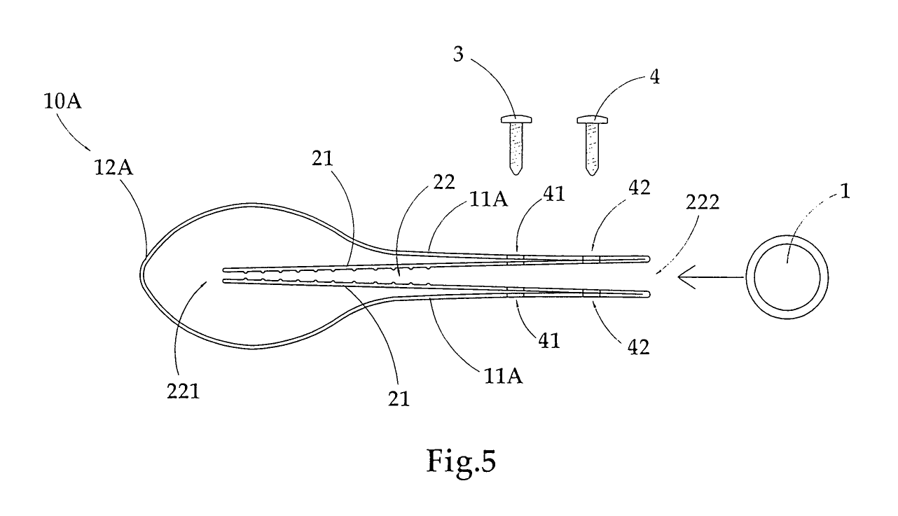

Alternatively, the outer holder 10A is formed to have a “keyhole” shape that the two holding panels 11A are preferably extended in a parallel manner, wherein the cornering panel 12A is preferred to be formed in a non-circular structure. Preferably, the cornering panel 12A is formed to have an oval structure, as shown in FIG. 5.

Accordingly, the cornering panel 12 has a curvature smaller than a curvature of the tubular object 1. In other words, the curvature of the cornering panel 12 is the curvature of the inner wall of the closed end 221 of the clipping channel 22.

Each of the clipping panels 21 further has an inner frictional surface 211 for pressing on the outer surface of the tubular object 1 to retain the tubular object 1 in position when the holding panels 11 are pressed towards each other. Accordingly, a frictional layer can be applied on the inner friction surface 211 of each of the clipping panels 21 to enhance the friction thereof. Alternatively, a plurality of lugs are protruded from the clipping panels 21 to form the inner frictional surface 211, wherein the lug can be point shape, elongate shape or any other shape for friction enhancement.

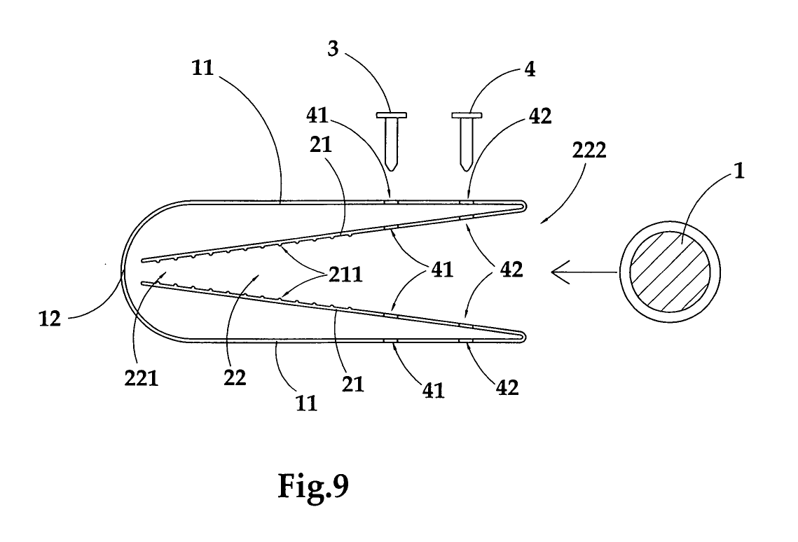

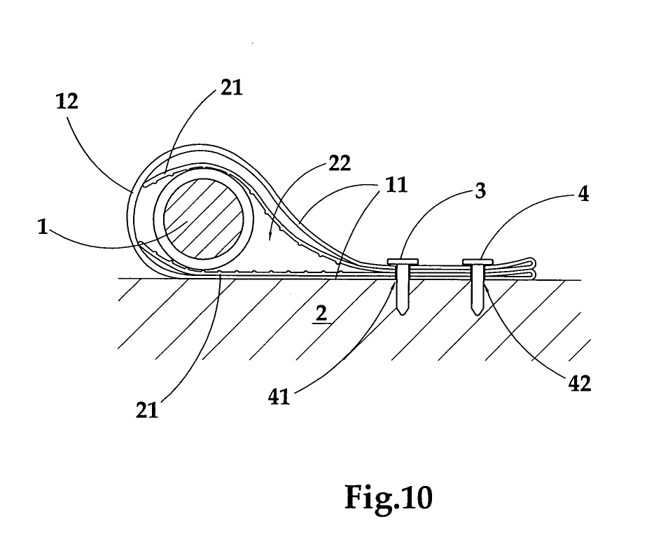

Alternatively, as illustrated in FIGS. 9 and 10, if the tubular object 1 has a relatively smaller diameter, and the curvature of the tubular object 1 is smaller than the curvature of the cornering panel 12, the clipping panels 21 can still apply enough pressure to retain the tubular object 1, because the cornering panel 12 restricts the position of the ends of the clipping panels 21, and the elastic force of the clipping panels 21 can retain the tubular object 1. In this manner, the self-secure mount can adapt to tubular objects with different sizes. Also, since the tubular object 1 is not directly attached to the cornering panel 12, and there is space between the inner holder 20 and the outer holder 10, the self-secure mount can absorb a mount of shock or movement at the same time.

Accordingly, the self-secure mount of the present invention is made of a one piece thin metal plate 30 having an elongated configuration.

In order to form the self-secure mount, the metal plate 30 is bent in a predetermined configuration. In particularly, as shown in FIG. 7, the method of manufacturing the self-secure mount of the present invention comprises the following steps.

(1) Provide then elongated thin metal plate 30 which is divided into four longitudinal sections, 31, 32, 33, 34.

(2) Overlappedly and spacedly fold two outer longitudinal sections 31, 34 on two inner longitudinal sections 32, 33 respectively.

(3) Overlappedly and spacedly fold the two outer longitudinal sections 31, 34 with each other at a position that the two outer longitudinal sections 31, 34 are overlappedly and spacedly sandwiched between the two inner longitudinal sections 32, 33 to form the clipping channel 22 between the two outer longitudinal sections 31, 34.

In other words, the two outer longitudinal sections 31, 34 forms the two clipping panels 21 respectively while the two inner longitudinal sections 32, 33 form the two holding panels 11.

Accordingly, in the step (2), when the two outer longitudinal sections 31, 34 on two inner longitudinal sections 32, 33 respectively, a gap must be formed between two edge ends of the outer longitudinal sections 31, 34. In other words, the edge ends of the outer longitudinal sections 31, 34 cannot be touched each other.

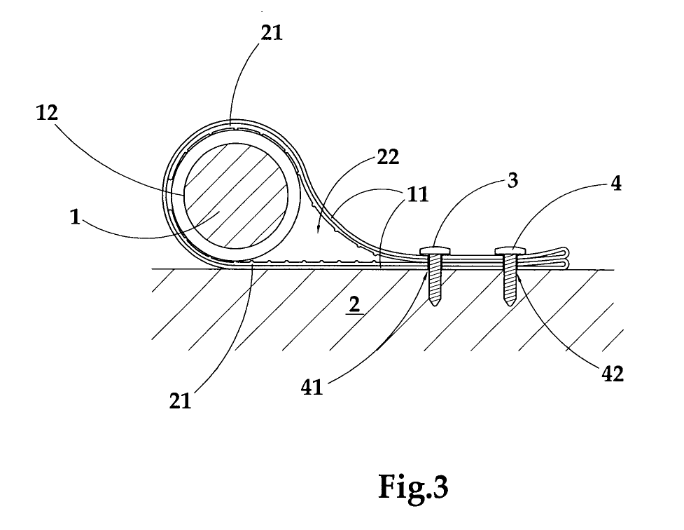

As shown in FIGS. 1 and 2, the self-secure mount further contains four mounting holes 41 provided on the holding panels 11 and the clipping panels 21 respectively, wherein the mounting holes 41 are aligned with each other for an elongated fastener passing therethrough to fix the outer and inner holders 10, 20 on a fixture 2 and to minimize the distance between the holding panels 11 at the same time. Accordingly, the elongated fastener can be a nail or a screw affixing to a wall surface of the fixture 2 through the mounting holes 41. Therefore, once the elongated fastener is affixed to the fixture 2, the holding panels 11 and the clipping panels 21 are pressed at the same time to retain the tubular object on the wall surface of the fixture 2, as shown in FIG. 3.

For better result, the self-secure mount further contains four retention holes 42 provided on the holding panels 11 and the clipping panels 21 respectively, wherein the retention holes 42 are spaced apart from the mounting holes 41 and are aligned with each other. Therefore, when two elongated fasteners are affixed to the fixture 2 through the mounting holes 41 and the retention holes 42, the self-secure mount of the present invention is securely affixed to the fixture 2 to prevent an unwanted movement of the outer and inner holders 10, 20 on the fixture 2.

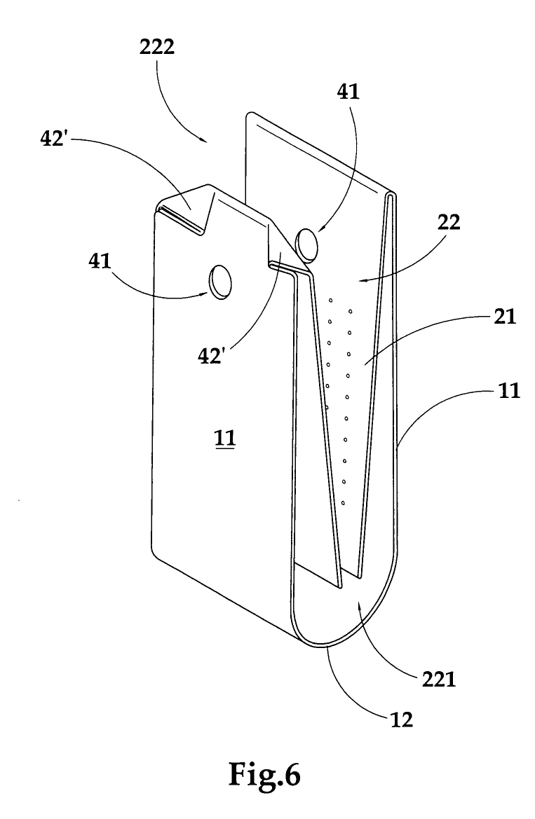

Alternatively, two corner portions of one of the holding panels 11 are folded outwardly to form two sharp tips 42′ for fixing on the fixture 2, as shown in FIG. 6. In other words, the two corresponding overlapped holding panel 11 and the clipping panel 21 are bent at the outer edges thereof to form the two sharp tips 42′ as the substitution of the retention hole 42. Therefore, the self-secure mount of the present invention is securely affixed to the fixture 2 to prevent an unwanted movement of the outer and inner holders 10, 20 on the fixture 2 via the sharp tips 42′ and the elongated fastener through the mounting holes 41. In other words, no retention hole 42 is formed.

According to the preferred embodiment, the self-secure mount of the present invention can be applied to mount different types of tubular objects 1 with different diameters. The distance between the clipping panels 21 is self-adjusted that the clipping panels 21 can press against the outer surface of the tubular object 1 when the tubular object 1 is slid along the clipping channel 22. In addition, two or more tubular objects 1 can be retained by the self-secure mount by sliding the tubular objects 1 along the clipping channel 22. The present invention can be used for telephone lines, power wires, and cables, including single-core, multiple-core, round lines, and flat lines. It can also be used for pipes, such as brass pipes, iron pipes, aluminum pipes, steel pipes, and other metal pipes, soft or hard plastic pipes, and rubber pipes.

In order to retain the tubular object 1 on the fixture 2 via the self-secure mount of the present invention, the user is able to perform the operation which comprises the following steps.

(A) Sliding the tubular object 1 towards the closed end 211 of the clipping channel 22 from the opened end 222 thereof.

(B) Retain the tubular object 1 at the two inner edges of the clipping panels 21 at a position closed to the cornering panel 12 of the outer holder 10. Therefore, the clipping panels 21 will apply the resilient force against the outer surface of the tubular object 1 at the inner edges of the clipping panels 21 to retain the tubular object 1 in position.

(C) Apply the pressing force at the two holding panels 11 of the outer holders 10. Once the distance between the holding panels 11 is minimized, the clipping force of the outer holder 10 is substantially increased towards the inner edges of the clipping panels 21 to hold the tubular object 1 within the cornering panel 12.

Accordingly, the pressing force can be applied by fixing the elongated fastener to the fixture 2 through the mounting holes 41. Another elongated fastener can be fixed to the fixture 2 through the retention holes 42 to prevent the unwanted movement of the self-secure mount on the fixture 2. Alternatively, the self-secure mount can be fixed on the fixture 2 to prevent the unwanted movement by fixing the sharp tips 42′ on the fixture 2 so as to omit a second hole formed on the fixture 2 by the second elongated fastener through the retention holes 42.

For the tubular object 1 having a bigger diameter, the self-secure mount of the present invention can be bent in an alternative configuration to retain the tubular object 1 on the fixture 1, as shown in FIG. 7. The outer and inner holders 10, 20 are bent outwardly that the holding panels 11 are aligned at a planer direction and the clipping panels 21 are also aligned at a planer direction. The tubular object 1 is placed at the gap between the inner edges of the clipping panels 21 to align with the cornering panel 12 of the outer holder 10. Then, the inner frictional surfaces 211 are biased against the fixture 1 such that when the holding panels 11 are pressed towards the clipping panels 21 respectively by fixing the elongated fasteners through the mounting holes 41 on the fixture 2 respectively, the clipping panels 21 apply the resilient force against the tubular object 1 at the inner edges of the clipping panels 21 to retain the tubular object 1 on the fixture, as shown in FIG. 7.

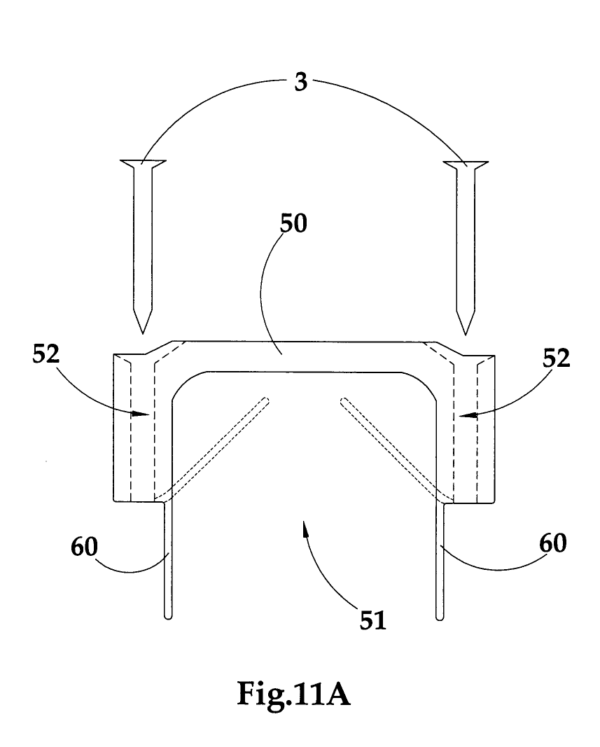

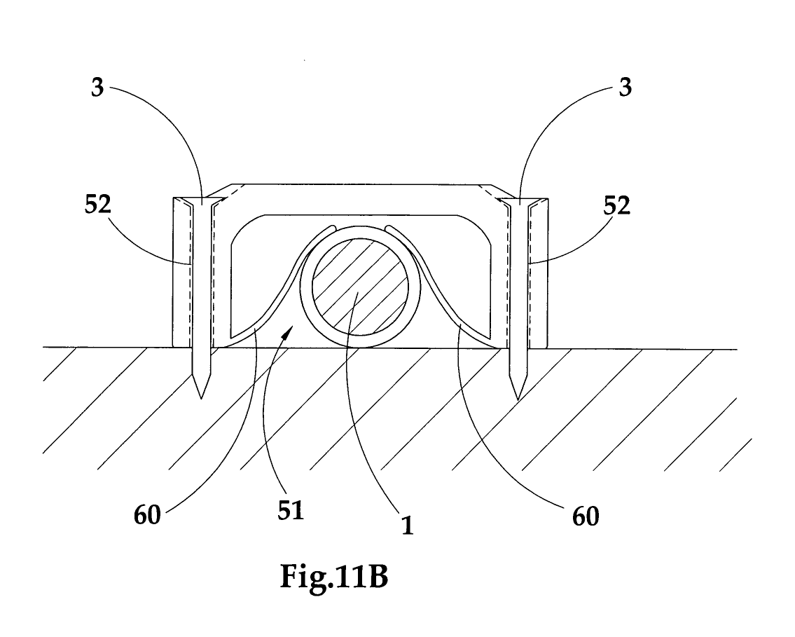

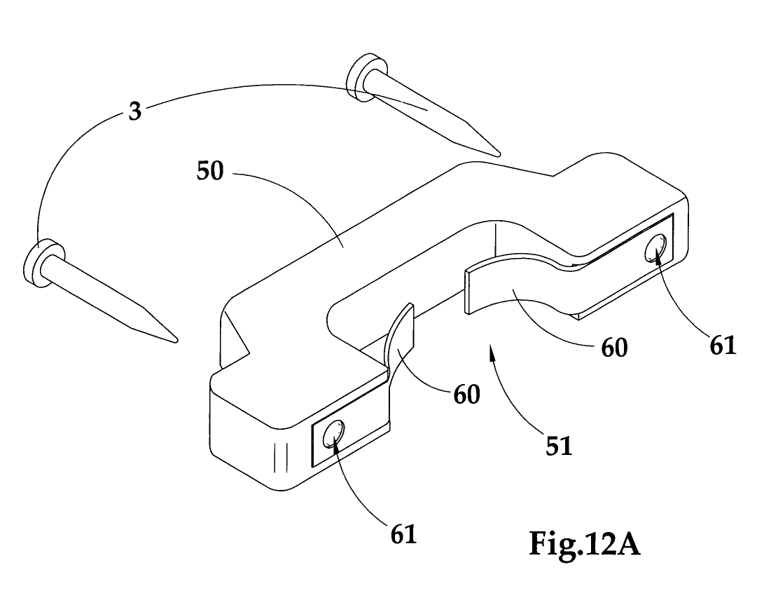

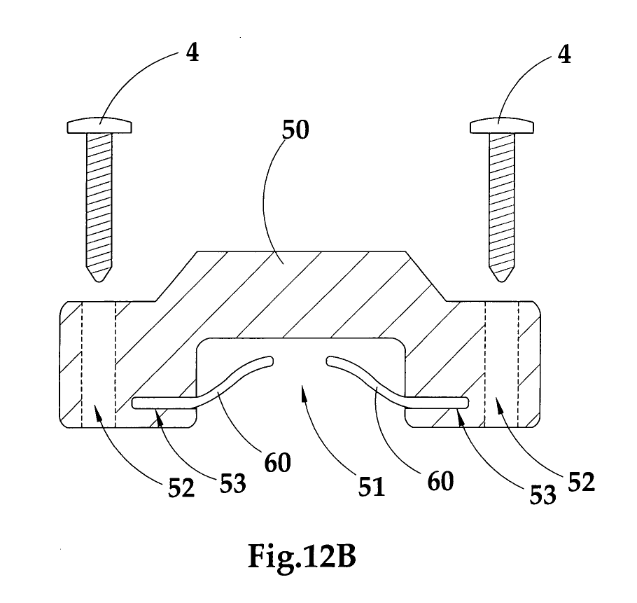

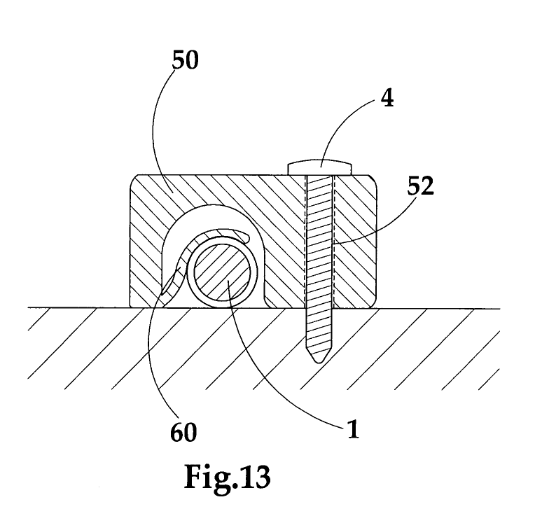

Referring to FIGS. 11 to 12 of the drawings, in an alternative embodiment of the present invention, the outer holder 10 is a saddle 50, and the inner holder comprises two clipping panels 60. The saddle 50 is made of hard material. It provides a holding channel 51, so when the saddle 50 is mounted, it can cross over the tubular object 1 and with the tubular object 1 inside the holding channel 51. The cross section of the holding channel 51 is generally larger than the cross section of the tubular object 1 so the holding channel 51 won't press the tubular object 1 directly. The saddle 50 also has two holding holes 52 at the two sides of the saddle 50 with the holding channel 51 in between, so the saddle 50 can be mounted on a surface firmly with nails or bolts 3. Referring to FIG. 13, in an alternative embodiment, the saddle 50 only has one holding hole 52 and one clipping panel 60, so use one nail or bolt can mount the Saddle 50 over a surface.

The saddle 50 can be made of plastic, wood, or metal. In an embodiment of the present invention, the saddle 50 is a piece of metal plate in Ω shape.

The clipping panel 60 is made of flexible material. One end of the clipping panel 60 is fixed on the outer holder, and the other end extends into the holding channel 51 and suspends there. Referring to FIG. 11B, when the saddle 50 is crossed over the tubular object 1 on a mounting surface, the clipping panel 60 will directly press on the tubular object 1. As the nails or bolts fastening the saddle 50, the clipping panel 60 will press the tubular object 1 with elastic force.

There are several ways of fixing the clipping panel 60 on the outer holder in alternative embodiments. Referring to FIG. 12A, the clipping panel 60 is piece of elongated plate. One end of the plate has a mounting hole 61 corresponding to the mounting hole on the outer holder. When mounting the self-secure mount over a surface, the clipping panel 60 is placed between them with the mounting holes 61 being aligned. So the nail or bolt can fasten the clipping panel 60 and the outer hold together. At the same time, the other end of the clipping panel 60 is suspended inside the holding channel 51. This part of the clipping panel 60 can be pre-curved for retaining the tubular object 1.

Referring to FIG. 12B, in an alternative embodiment, the saddle 50 has one or two slots 53, so one end of the clipping panel 60 can be embedded into the slot 53 with the other end suspended in the control channel. Referring to FIG. 11A, in another alternative embodiment, the outer holder and the clipping panel 60 are made of plastic material and are originally mold together. Since the clipping panel 60 is much thinner to be flexible to provide elastic force. In another alternative embodiment, the saddle 50 is a piece of metal plate in)-shape. One end of the clipping panel 60 is folded in U-shape, so one end of the O-shaped metal plate can be embedded into this U-shape of the clipping panel 60. The other end of the clipping panel 60 is pre-curved and extends into the holding channel 51 from the bottom of the saddle 50. Two pieces of clipping panel 60 can be used in this embodiment. In another embodiment, the clipping panel 60 is an elongated plate which is pre-formed according to the contour of the outer hold, so the saddle 50 can be embedded into said clipping panel 60. At the same time, the two ends of the elongated plate extend into the holding channel 51 of the saddle 50 from the bottom.

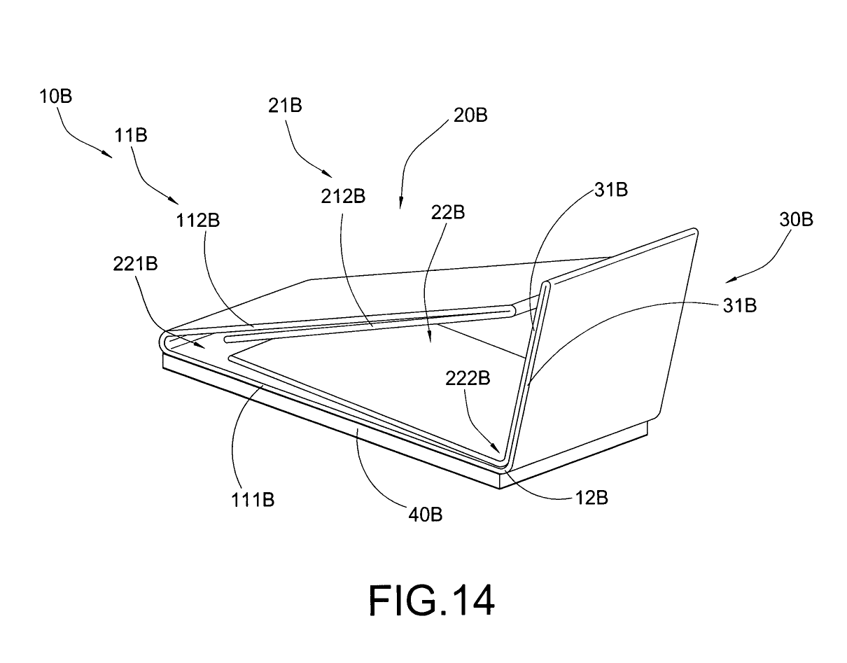

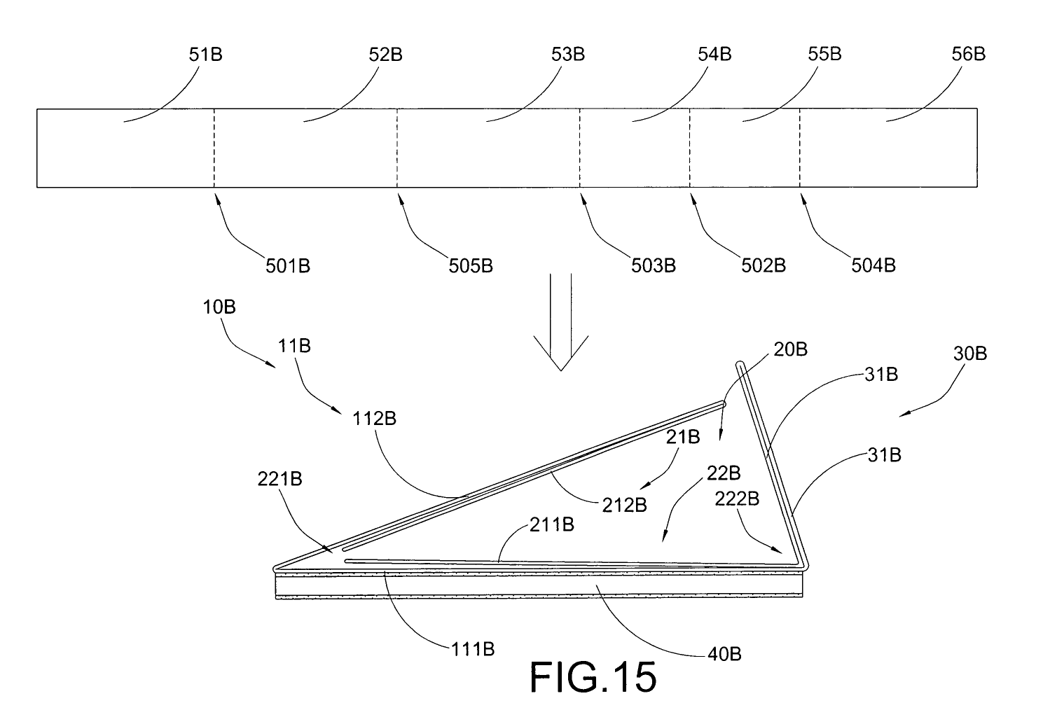

As shown in FIGS. 14 and 15, a self-secure mount according to a ninth embodiment of the present invention illustrates another alternative mode of the first embodiment, wherein the self-secure mount comprises an outer holder 10B and an inner holder 20B.

The outer holder 10B, which is made of flexible material, comprises two spaced apart holding panels 11B spacedly overlapping with each other, and a cornering panel 12B integrally extended between the two holding panels 11B for applying an elastic clipping force between the holding panels 11B. Preferably, the cornering panel 12B is an arc-shaped panel extended between the holding panel 11B for enabling the two holding panels 11B being bent to overlap with each other. It is appreciated that the cornering panel 12B can be formed in any angled shape to connect the two holding panels 11B.

Accordingly, the two holding panels 11B are defined as first holding panel 111B and a second holding panel 112B which preferably has the same size and shape of the first holding panel 111B. The cornering panel 12B is integrally extended from two outer edges of the first and second holding panels 111B, 112B for applying an elastic clipping force between the first and second holding panels 111B, 112B.

The inner holder 20B, which is also made of flexible material, comprises two spaced apart clipping panels 21B overlapping with each other to define a clipping channel 22B between the holding panels 11B of the outer holder 10B. Accordingly, the two clipping panels 21B are defined as a first clipping panel 211B and a second clipping panel 212B.

Two outer edges of the first and second clipping panels 211B, 212B are extended from two outer edges of the first and second holding panels 111B, 112B respectively while two inner edges of the clipping panels 21 are extended towards a closed end 221B of the clipping channel 22B at the cornering panel 12B of the outer holder 10B.

The two inner edges of the first and second clipping panels 211B, 212B are adapted for pressing against an outer surface of the tubular object 1 to retain the tubular object 1 in position, such that when the first and second holding panels 111B, 112B are pressed to minimize a distance therebetween, the clipping force of the outer holder 10 is substantially increased towards the inner edges of the first and second clipping panels 211B, 212B to hold the tubular object 1 at the cornering panel 12. It is worth to mention that when the first and second holding panels 111B, 112B are pressed towards each other, the first and second clipping panels 211B, 212B are driven to be pressed at the same time such that the resilient force is generated at the inner edges of the first and second clipping panels 211B, 212B to retain the tubular object 1 in position. In addition, since the tubular object 1 is clipped between the first and second clipping panels 211B, 212B by means of resilient force, the outer surface of the tubular object 1 will not be damaged.

According to the preferred embodiment, the clipping channel 22B defines the closed end 221B at the cornering panel 12B and an opened end 222B at the outer edges of the clipping panels 21B. A width of the clipping channel 22B, which is a distance between the two clipping panels 21B, is smaller than a diameter of the tubular object 1. Preferably, the width of the clipping channel 22B is gradually reducing from the opened end 222B to the closed end 221B, as shown in FIG. 15.

The outer holder 10B is formed to have a U-shape or V-shape that the two holding panels 11B are extended from the cornering panel 12B and are adapted to overlap with each other by means of pressing force. Preferably, the cornering panel 12B has a curvature smaller than a curvature of the tubular object 1. In other words, the curvature of the cornering panel 12B is the curvature of the inner wall of the closed end 221B of the clipping channel 22B.

It is worth mentioning that the two inner edges of the first and second clipping panels 211B, 212B are adapted for pressing against the outer surface of the tubular object 1 to retain the tubular object 1 in position, such that when the first and second holding panels 111B, 112B are pressed to minimize the distance therebetween, the clipping force of the outer holder 10B is substantially increased towards the inner edges of the first and second clipping panels 211B, 212B to hold the tubular object 1 in position

The self-secure mount further comprises a releasable locker 30B extended from the outer edge of the first holding panel 111B, wherein the releasable locker 30B is bendable at the connection between the releasable locker 30B and the outer edge of the first holding panel 111B. Accordingly, when the outer edges of the first and second holding panels 111B, 112B are pressed to minimize the distance therebetween, the releasable locker 30B is pressed to overlap on the second holding panel 112B so as to retain the outer edges of the first and second holding panels 111B, 112B together.

According to the preferred embodiment, the releasable locker 30B is extended from the outer edge of the first holding panel 111B to releasably open/close the opened end 222B of the clipping channel 22B. When the releasable locker 30B is bent outwardly from the second holding panel 112B, the opened end 222B of the clipping channel 22B will be opened up. Likewise, when the releasable locker 30B is bent to overlap on the second holding panel 112B, the distance between the outer edges of the first and second holding panels 111B, 112B is minimized so as to close the opened end 222B of the clipping channel 22B. It is worth mentioning that once the releasable locker 30B is pressed on the second holding panel 112B, the releasable locker 30B will remained at the position to retain the minimum distance between the outer edges of the first and second holding panels 111B, 112B.

As shown in FIG. 15, the releasable locker 30B comprises two locker panels 31B being overlapped with each other, wherein the locker panels 31B are extended from the outer and inner holders 10B, 20B edge-to-edge respectively. In particular, the locker panels 31B are integrally extended from the outer edge of the first holding panel 111B and the outer edge of the first clipping panel 211B respectively.

Preferably, the outer holder 10B, the inner holder 20B, and the releasable locker 30B are integrated and made by one piece thin metal plate. As shown in FIG. 15, the outer edge of the second holding panel 112B is integrally extended from the outer edge of the second clipping panel 212B.

According to the preferred embodiment, a length of the releasable locker 30B is shorter than a length of each of the first and second holding panels 111B, 112B. In other words, the length of each of the locker panels 31B is shorter than the length of each of the first and second holding panels 111B, 112B. Therefore, when the releasable locker 30B is pressed to overlap on the second holding panel 112B, the locker panels 31B are only overlapped on the outer portion of the second holding panel 112B to retain the minimum distance between the outer edges of the first and second holding panels 111B, 112B.

The self-secure mount further comprises an adhering layer 40B provided at an outer surface of the first holding panel 111B for affixing the outer and inner holders 10B, 20B on a fixture, such as a wall surface. Preferably, the adhering layer 40B is a double-sided adhering element that one side of the adhering layer 40B is affixed to the outer surface of the first holding panel 111B while another opposed side of the adhering layer 40B can be affixed to the fixture.

Accordingly, as it is mentioned above, the self-secure mount of the present invention is made of a one piece thin metal plate having an elongated configuration, as shown in FIG. 15.

In order to form the self-secure mount, the metal plate 50B is bent in a predetermined configuration. In particularly, the method of manufacturing the self-secure mount of the present invention comprises the following steps.

(1) Provide the elongated thin metal plate 50B which is divided into six longitudinal sections 51B, 52B, 53B, 54B, 55B, 56B, wherein the six longitudinal sections 51B, 52B, 53B, 54B, 55B, 56B are defined from edge-to-edge respectively. The length of the first longitudinal section 51B preferably equals to the length of the sixth longitudinal section 56B. The length of the second longitudinal section 52B preferably equals to the length of the third longitudinal section 53B. The length of the fourth longitudinal section 54B preferably equals to the length of the fifth longitudinal section 55B. Accordingly, a first bending line 501B is defined between the first and second longitudinal sections 51B, 52B. A second bending line 502B is defined between the fourth and fifth longitudinal sections 54B, 55B. A third bending line 503B is defined between the third and fourth longitudinal sections 53B, 54B. A fourth bending line 504B is defined between the fifth and sixth longitudinal sections 55B, 56B. A fifth bending line 505B is defined between the second and third longitudinal sections 52B, 53B.

(2) Overlap the first longitudinal section 51B with the second longitudinal section 52B along the first bending line 501B.

(3) Overlap the sixth and fifth longitudinal sections 56B, 55B on the third and fourth longitudinal sections 53B, 54B respectively along the second bending line 502B. Accordingly, the third bending line 503B will align with the fourth bending line 504B such that the sixth longitudinal section 56B is overlapped on the third longitudinal section 53B while the fifth longitudinal section 55B is overlapped on the fourth longitudinal section 54B.

(4) Bend the second longitudinal section 52B with respect to the third longitudinal section 53B along the fifth bending line 505B.

(5) Bend the fourth and fifth longitudinal sections 54B, 55B together with respect to the third and sixth longitudinal sections 53B, 56B along the third and fourth bending lines 503B, 504B.

Therefore, the first and sixth longitudinal sections 51B, 56B form the first and second clipping panels 211B, 212B of the inner holder 20B respectively. The second and third longitudinal sections 52B, 53B forms the first and second holding panels 111B, 112E of the outer holder 10B respectively. The area around the fifth bending line 505B forms the cornering panel 12B of the outer holder 10B. The fourth and fifth longitudinal sections 54B, 55B form the two locker panels 31B respectively.

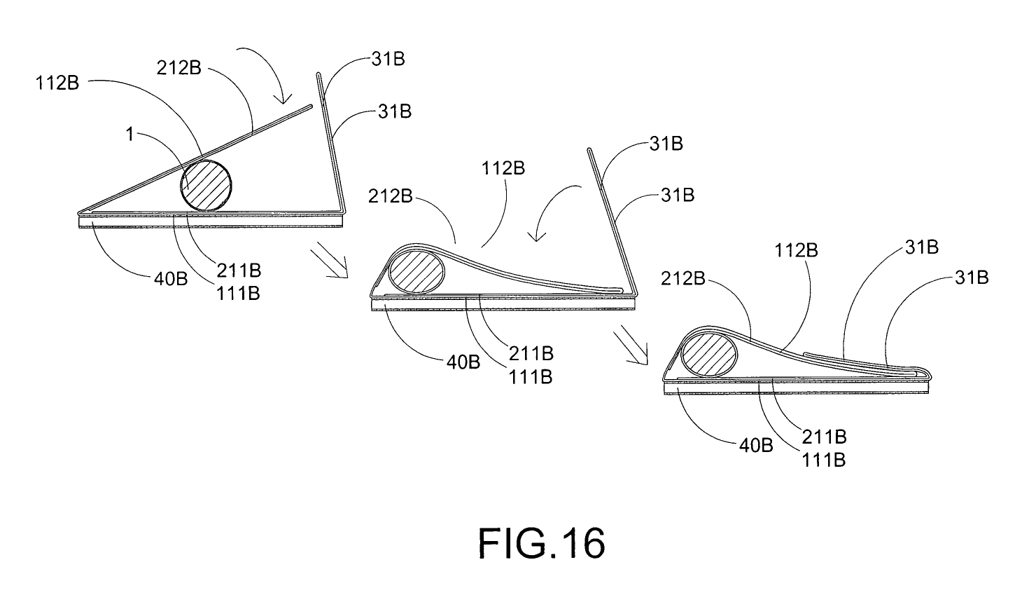

According to the preferred embodiment, a method of holding the tubular object 1 by the self-secure mount is also provided, wherein the method comprises the following steps, as shown in FIG. 16.

(A) Place the tubular object between the first and second clipping panels 211B, 212B of the inner holder 20B for applying the elastic force at the outer surface of the tubular object 1. Accordingly, a portion of the tubular object 1 can be slid into clipping channel 22B towards the closed end 211B of the clipping channel 22B from the opened end 222B thereof. It is worth mentioning that the portion of the tubular object 1 is preferably retained at the two inner edges of the first and second clipping panels 211B, 212B at a position closed to the cornering panel 12B of the outer holder 10B. Therefore, the first and second clipping panels 211B, 2128 will apply the resilient force against the outer surface of the tubular object 1 at the inner edges of the first and second clipping panels 211B, 212B to retain the tubular object 1 in position.

(B) Apply the pressing force at the first and second holding panels 111B, 112B of the outer holder 10B. Once the distance between the first and second holding panels 111B, 112B is minimized, the clipping force of the outer holder 10B is substantially increased towards the inner edges of the first and second clipping panels 211B, 212B to hold the tubular object 1 within the cornering panel 12B.

(C) Retain the pressing force at the outer edges of the first and second holding panels to minimize the distance therebetween so as to hold the tubular object in position.

In the step (c), the pressing force is retained by the releasable locker 30B, wherein when the releasable locker 30B is pressed to overlap on the second holding panel 112B, the outer edges of the first and second holding panels 111B, 112B are pressed together, so as to retain the distance between the outer edges of the first and second holding panels 111B, 112B at the minimum distance.

It is worth mentioning that the pressing force can be applied by fixing the elongated fastener to the fixture through the mounting holes 41, as it is mentioned above, wherein another elongated fastener can be fixed to the fixture through the retention holes 42 to prevent the unwanted movement of the self-secure mount on the fixture 2. Alternatively, the self-secure mount can be fixed on the fixture to prevent the unwanted movement by fixing the sharp tips 42′ on the fixture so as to omit a second hole formed on the fixture by the second elongated fastener through the retention holes 42.

In order to remove the tubular object 1 from the self-secure mount of the present invention, the user is able to bend the releasable locker 30B outwardly so as to open up the opened end 222B of the clipping channel 22B. Once the releasable locker 30B is bent outwardly, the pressing force at the outer holder 10B is released. Therefore, the outer edges of the first and second holding panels 111B, 112B will move away from each other. Then, the tubular object 1 can be slid out of the clipping channel 22B from the closed end 211B of the clipping channel 22B to the opened end 222B thereof, so as to remove the tubular object 1 from the self-secure mount of the present invention. It is worth mentioning that the self-secure mount of the present invention is reusable that two or more tubular objects 1 can be held within the clipping channel 22B at the same time and the tubular objects 1 can be replacably held within the clipping channel 228 by folding the releasable locker 30B.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A self-secure mount for a tubular object, comprising:
an outer holder for retaining said self-secure mount in position, wherein said outer holder comprises first and second holding panels defining a clipping channel therebetween for holding said tubular object, and a cornering panel extended between said first and second holding panels for applying an elastic clipping force between said first and second holding panels; and
an inner holder, which is made of flexible material, comprising first and second clipping panels extended between said first and second holding panels of said outer holder for pressing against an outer surface of said tubular object by elastic force;
wherein two outer edges of said first and second clipping panels are extended from two outer edges of said first and second holding panels while two inner edges of said first and second clipping panels are extended towards a closed end of said clipping channel at said cornering panel of said outer holder;
wherein said two inner edges of said first and second clipping panels are adapted for pressing against said outer surface of said tubular object to retain said tubular object in position, such that when said first and second holding panels are pressed to minimize a distance therebetween, said clipping force of said outer holder is substantially increased towards said inner edges of said first and second clipping panels to hold said tubular object in position.

2. The self-secure mount, as recited in claim 1, further comprising a releasable locker extended from said outer edge of said first holding panel and arranged in such a manner that when said outer edges of said first and second holding panels are pressed to minimize said distance therebetween, said releasable locker is pressed to overlap on said second holding panel so as to retain said outer edges of said first and second holding panels together.

3. The self-secure mount, as recited in claim 2, wherein said releasable locker comprises two overlapped locker panels integrally extended from said outer edge of said first holding panel and said outer edge of said first clipping panel respectively.

4. The self-secure mount, as recited in claim 2, wherein said outer edge of said second holding panel is integrally extended from said outer edge of said second clipping panel.

5. The self-secure mount, as recited in claim 3, wherein said outer edge of said second holding panel is integrally extended from said outer edge of said second clipping panel.

6. The self-secure mount, as recited in claim 2, wherein a length of said releasable lock is shorter than a length of each of said first and second holding panels.

7. The self-secure mount, as recited in claim 5, wherein a length of said releasable lock is shorter than a length of each of said first and second holding panels.

8. The self-secure mount, as recited in claim 1, further comprising an adhering layer provided at an outer surface of said first holding panel for affixing said outer and inner holders on a fixture.

9. The self-secure mount, as recited in claim 7, further comprising an adhering layer provided at an outer surface of said first holding panel for affixing said outer and inner holders on a fixture.

10. The self-secure mount, as recited in claim 3, wherein said outer holder, said inner holder, and said releasable locker are integrated and made by one piece thin metal plate.

11. The self-secure mount, as recited in claim 9, wherein said outer holder, said inner holder, and said releasable locker are integrated and made by one piece thin metal plate.

12. The self-secure mount, as recited in claim 1, further containing four mounting holes provided on said holding panels and said clipping panels respectively, wherein said mounting holes are aligned with each other for an elongated fastener passing therethrough to fix said outer and inner holders on a fixture and to minimize the distance between said holding panels.

13. The self-secure mount, as recited in claim 12, wherein two corner portions at said outer edges of said holding panels are folded outwardly to form two sharp tips for fixing on said fixture.

14. The self-secure mount, as recited in claim 11, wherein said cornering panel has a curvature smaller than a curvature of said tubular object.

15. The self-secure mount, as recited in claim 13, wherein said cornering panel has a curvature smaller than a curvature of said tubular object.

16. A method of holding a tubular object by a self-secure mount which comprises an outer holder and an inner holder, wherein the method comprises the steps of;
(a) placing said tubular object between first and second clipping panels of said inner holder for applying an elastic force at an outer surface of said tubular object;
(b) applying a pressing force at first and second holding panels of said outer holder, wherein two outer edges of said first and second clipping panels are extended from two outer edges of said first and second holding panels while two inner edges of said first and second clipping panels are extended towards a closed end of a clipping channel formed between said first and second holding panels; and
(c) retaining said pressing force at said outer edges of said first and second holding panels to minimize a distance therebetween so as to hold said tubular object in position.

17. The method, as recited in claim 16, wherein the step (c) further comprises a step of pressing a releasable locker, which is extended from said outer edge of said first holding panel, to overlap on said second holding panel so as to retain said outer edges of said first and second holding panels together.

18. The method, as recited in claim 17, wherein said releasable locker comprises two overlapped locker panels integrally extended from said outer edge of said first holding panel and said outer edge of said first clipping panel respectively, wherein said outer edge of said second holding panel is integrally extended from said outer edge of said second clipping panel.

19. The method, as recited in claim 16, further comprising a step of affixing said outer and inner holders on a fixture by an adhering layer which is provided at an outer surface of said first holding panel.

20. The method, as recited in claim 18, further comprising a step of affixing said outer and inner holders on a fixture by an adhering layer which is provided at an outer surface of said first holding panel.
